(19) United States
(12) Patent Application Publication
(10) Pub. No.: US 2020/0049815 A1
(43) Pub. Date: Feb. 13, 2020

(54) ANGULAR LOCALIZATION VIA CONTROLLED MOTION OF RADAR SYSTEM

(71) Applicant: GM Global Technology Operations LLC, Detroit, MI (US)

(72) Inventors: Oren Longman, Tel Aviv (IL); Shahar Villeval, Tel Aviv (IL); Igal Bilik, Rehovot (IL)

(21) Appl. No.: 16/059,617

(22) Filed: Aug. 9, 2018

(51) Int. Cl. G01S 13/93; G01S 13/86; G01S 7/35

(52) U.S. Cl. CPC G01S 13/931; G01S 2007/356; G01S 7/352; G01S 13/86

(57) ABSTRACT

A radar system includes a transmit channel, and a transmit antenna to transmit a signal generated by the transmit channel. The radar system also includes a movement device to cause controlled movement of the transmit antenna. A controller controls the movement device. The controlled movement is used to improve an estimate of azimuth angle to an object detected by the radar system.

### INTRODUCTION

The subject disclosure relates to improving angular localization via controlled motion of a radio detection and ranging (radar) system.

Vehicles (e.g., automobiles, trucks, construction equipment, farm equipment, automated manufacturing equipment) increasingly use sensors to detect objects in their vicinity. The detection may be used to augment or automate vehicle operation. Exemplary sensors include cameras, light detection and ranging (lidar) systems, and radar systems. The radar may output a frequency modulated continuous wave (FMCW) signal and, more particularly, a linear frequency modulated continuous wave (LFMCW) signal, referred to as a chirp. When there is relative motion between the radar system and the object being detected, a shift in the frequencies of received reflections from the transmitted frequencies is referred to as the Doppler shift and facilitates the determination of additional information about the object. When both the radar system and the object are stationary, the Doppler effect cannot be used. Accordingly, it is desirable to improve angular localization of detected objects via controlled motion of the radar system.

### SUMMARY

In one exemplary embodiment, a radar system includes a transmit channel, and a transmit antenna to transmit a signal generated by the transmit channel. The radar system also includes a movement device to cause controlled movement of the transmit antenna, and a controller to control the movement device. The controlled movement is used to improve an estimate of azimuth angle to an object detected by the radar system.

In addition to one or more of the features described herein, the movement device is a Micro-Electro-Mechanical systems (MEMS) or piezoelectric MEMS device.

In addition to one or more of the features described herein, the radar system also includes an accelerometer to measure the controlled movement.

In addition to one or more of the features described herein, the radar system also includes a plurality of the transmit channels.

In addition to one or more of the features described herein, the radar system also includes an array of the transmit antennas corresponding to the plurality of the transmit channels.

In addition to one or more of the features described herein, the array of the transmit antennas undergoes the controlled movement individually or collectively.

In addition to one or more of the features described herein, the radar system also includes a processor to process reflections received based on reflection of transmissions of the signal by one or more of the objects. The reflections form a three-dimensional cube of data with a time dimension, a chirp dimension associated with the signal that is transmitted, and a channel dimension.

In addition to one or more of the features described herein, the processor performs a first fast Fourier transform (FFT) to convert the time dimension to a range dimension, perform a second FFT to convert the chirp dimension to a Doppler dimension, and perform a beamforming process to convert the channel dimension to a beam dimension that indicates azimuth angle to the one or more of the objects.

In addition to one or more of the features described herein, the processor isolates a Doppler component resulting from the controlled movement to obtain a refined azimuth angle to the one or more of the objects.

In addition to one or more of the features described herein, the radar system is in or on a vehicle.

In another exemplary embodiment, a method of improving angular localization in a radar system includes coupling a movement device to the radar system to cause controlled movement of a transmit antenna of the radar system that transmits a signal generated by a transmit channel of the radar system. The method also includes configuring a controller to control the movement device. The controlled movement is used to improve the angular localization including an azimuth angle to an object detected by the radar system.

In addition to one or more of the features described herein, the coupling the movement device includes coupling a Micro-Electro-Mechanical systems (MEMS) or piezoelectric MEMS device to the radar system.

In addition to one or more of the features described herein, the method also includes coupling an accelerometer to the radar system to measure the controlled movement.

In addition to one or more of the features described herein, the radar system includes a plurality of the transmit channels and an array of the transmit antennas corresponding to the plurality of the transmit channels, and the coupling the movement device results in individually or collectively moving each of the transmit antennas of the array of the transmit antennas.

In addition to one or more of the features described herein, the method also includes processing reflections received based on reflection of transmissions of the signal by one or more of the objects, wherein the reflections form a three-dimensional cube of data with a time dimension, a chirp dimension associated with the signal that is transmitted, and a channel dimension, and the processing also includes performing a first fast Fourier transform (FFT) to convert the time dimension to a range dimension, performing a second FFT to convert the chirp dimension to a Doppler dimension, and performing a beamforming process to convert the channel dimension to a beam dimension that indicates azimuth angle to the one or more of the objects.

In addition to one or more of the features described herein, the processing also includes isolating a Doppler component resulting from the controlled movement to obtain a refined azimuth angle to the one or more of the objects.

In yet another exemplary embodiment, a vehicle includes a radar system that includes a transmit channel, and a transmit antenna to transmit a signal generated by the transmit channel. The radar system also includes a movement device to cause controlled movement of the transmit antenna and a controller to control the movement device. The controlled movement is used to improve an estimate of azimuth angle to an object detected by the radar system. The vehicle also includes a vehicle controller to augment or automate operation of the vehicle based on information from the radar system.

In addition to one or more of the features described herein, the vehicle also includes a plurality of the transmit channels and an array of the transmit antennas corresponding to the plurality of the transmit channels. The array of the transmit antennas undergoes the controlled movement individually or collectively.

In addition to one or more of the features described herein, the vehicle also includes a processor to process reflections received based on reflection of transmissions of the signal by one or more of the objects. The reflections form a three-dimensional cube of data with a time dimension, a chirp dimension associated with the signal that is transmitted, and a channel dimension. The processor is configured to perform a first fast Fourier transform (FFT) to convert the time dimension to a range dimension, perform a second FFT to convert the chirp dimension to a Doppler dimension, and perform a beamforming process to convert the channel dimension to a beam dimension that indicates azimuth angle to the one or more of the objects.

In addition to one or more of the features described herein, the processor isolates a Doppler component resulting from the controlled movement to obtain a refined azimuth angle to the one or more of the objects.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a block diagram of a scenario involving a radar system according to one or more embodiments;

FIG. 2 details aspects of the radar system that facilitate controlled motion according to one or more embodiments;

FIG. 3 is a process flow of a method of performing object detection using controlled motion of a radar system according to one or more embodiments; and

FIG. 4 indicates an azimuth according to an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

As previously noted, relative motion between the radar system and an object detected by the radar system results in a Doppler shift in the frequency of the received signal as compared with the frequency of the transmitted signal. When both the radar system and the object being detected are stationary, this Doppler shift is not present. In this case, separation of multiple detected objects is more challenging. Embodiments of the systems and methods detailed herein relate to improving angular localization of objects via controlled motion of the radar system. Micro-Electro-Mechanical systems (MEMS) or piezoelectric MEMS may be used to move the antenna board or antenna patches of the radar system, for example. This controlled motion results in modulation of the transmitted signals. When the platform of the radar system (e.g., vehicle) and the object are both stationary, the controlled motion of the radar system increases separability among detected objects. In addition, because Doppler information is angle-dependent, angular localization accuracy (i.e., estimation of the azimuth angle to the detected object) is improved.

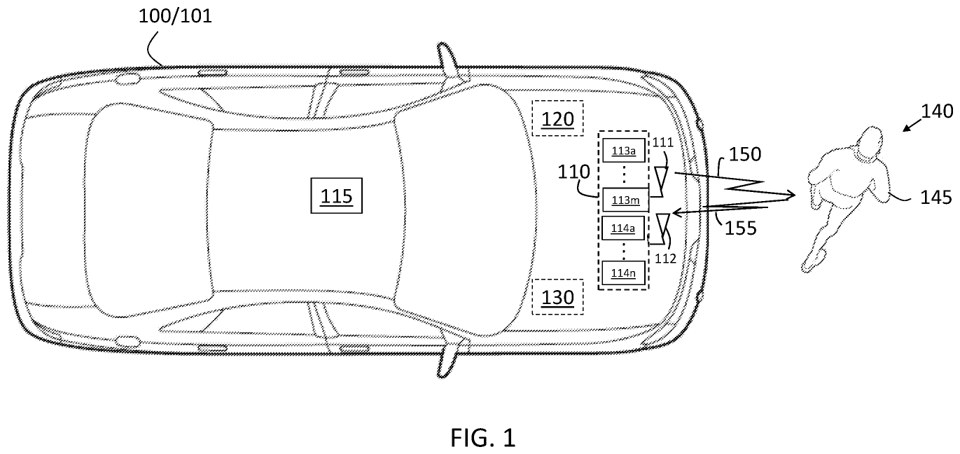

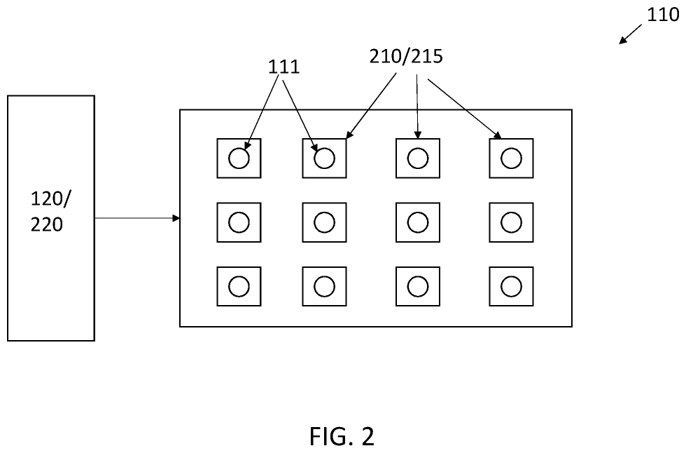

In accordance with an exemplary embodiment, FIG. 1 is a block diagram of a scenario involving a radar system 110. The vehicle 100 shown in FIG. 1 is an automobile 101. The radar system 110 may be a multi-input multi-output (MIMO) system with a number of transmit channels 113a through 113m (generally referred to as 113) and a number of receive channels 114a through 114n (generally referred to as 114). While a single transmit antenna 111 that transmits a transmit signal 150 and a single receive antenna 112 that receives a resulting reflection 155 is shown in FIG. 1, the array of transmit antennas 111 are further discussed with reference to FIG. 2. The exemplary radar system 110 is shown under the hood of the automobile 101. According to alternate or additional embodiments, one or more radar systems 110 may be located elsewhere in or on the vehicle 100. Another sensor 115 (e.g., camera, sonar, lidar system) is shown, as well. Information obtained by the radar system 110 and one or more other sensors 115 may be provided to a controller 120 (e.g., electronic control unit (ECU)) for image or data processing, object recognition, and subsequent vehicle control.

The controller 120 may use the information to control one or more vehicle systems 130. In an exemplary embodiment, the vehicle 100 may be an autonomous vehicle and the controller 120 may perform vehicle operational control using information from the radar system 110 and other sources. In alternate embodiments, the controller 120 may augment vehicle operation using information from the radar system 110 and other sources as part of a vehicle system (e.g., collision avoidance system, adaptive cruise control system, driver alert). The radar system 110 and one or more other sensors 115 may be used to detect objects 140, such as the pedestrian 145 shown in FIG. 1. The controller 120 may include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

FIG. 2 details aspects of the radar system 110 that facilitate improved angular localization via controlled motion according to one or more embodiments. Transmit antennas 111 are shown in an exemplary array of three rows and four columns. Each transmit antenna 111 is associated with a movement device 210, as shown. Each transmit antenna 111 may also be associated with an accelerometer 215, as shown, to measure the movement velocity of the transmit antenna 111. As previously noted, the movement device 210 may be a MEMS or piezoelectric MEMS device. A processor 220 that is part of the radar system 110 or the controller 120 may provide an electrical signal (e.g., voltage, current) to trigger movement of the MEMS device. Thus, the processor 220 or controller 120 controls the motion of each transmit antenna 111 by controlling movement of the associated movement device 210.

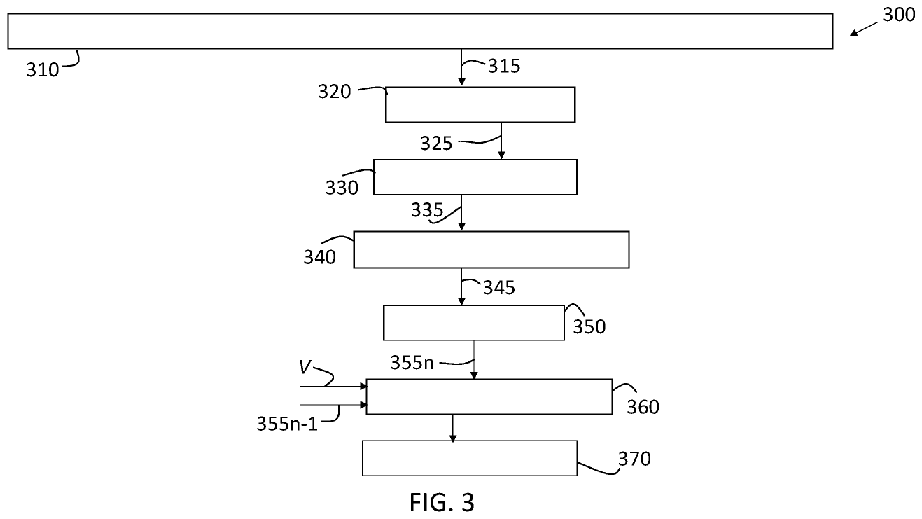

Each transmit antenna 111 may be moved in turn to correspond with transmission by the transmit antenna 111. As a result of the motion, the transmitted signal 150 undergoes frequency modulation. While each transmit antenna 111 is associated with a movement device 210 and accelerometer 215, according to an exemplary embodiment, the array of transmit antennas 111 (e.g., an antenna board) may be associated with one movement device 210 and accelerometer 215 such that all the transmit antennas 111 are moved together according to an alternate embodiment. According to another alternate embodiment, the entire radar system 110 may be moved together. The processing used to obtain additional information based on this movement is discussed with reference to FIG. 3.

FIG. 3 is a process flow of a method 300 of performing object detection using controlled motion of a radar system 110 according to one or more embodiments. At block 310, transmitting a transmit signal 150 (e.g., chirp) while implementing controlled motion, obtaining reflections 155 resulting from one or more objects 140 reflecting the transmit signal 150, and performing analog-to-digital conversion results in samples 315. The samples 315 represent a three-dimensional data cube with a time dimension, a chirp dimension, and a channel dimension.

At block 320, performing a range fast Fourier transform (FFT) includes converting the time dimension of the three-dimensional data cube to range. The result of the range FFT is an indication of energy distribution across ranges detectable by the radar for each chirp that is transmitted, and there is a different range FFT associated with each receive channel and each transmit channel. Thus, the total number of range FFTs is a product of the number of transmitted chirps and the number of receive channels. Based on the range FFT, the time-chirp-channel data cube is converted to range-chirp-channel cube 325 indicating a range-chirp map per channel.

At block 330, performing Doppler FFT refers to converting the chirp dimension to Doppler in the range-chirp-channel data cube. The Doppler FFT provides a range-Doppler map per receive channel or a range-Doppler-channel cube 335. For each receive channel and transmit channel pair, all the chirps are processed together for each range bin of the range-chip map (obtained with the range FFT). The result of the Doppler FFT per receive channel, the range-Doppler map, indicates the relative velocity of each detected object 140 along with its range. The number of Doppler FFTs is a product of the number of range bins and the number of receive channels.

Because of the controlled motion, at block 310, separability of detected objects 140 is improved at this stage. For example, two objects 140 that are close together and static have little separability in range and azimuth. The controlled motion of transmit antennas 111 results in each of the objects 140 projecting a different Doppler (i.e., a different Doppler frequency for each object 140), thereby facilitating the separation of the two objects.

At block 340, performing digital beamforming results in a range-Doppler (relative velocity) map per beam or a range-Doppler-beam cube 345. That is, digital beamforming converts the channel dimension to beam. Digital beamforming involves obtaining a vector of complex scalars from the vector of received signals and the matrix of actual received signals at each receive element for each angle of arrival of a reflection. At block 350, performing detection includes obtaining an azimuth angle and elevation angle to each of the detected objects 140 based on a thresholding of the complex scalars of the vector obtained in the digital beamforming process at block 340. The outputs 355n that are ultimately obtained, at block 350, for the current frame n from the processes at blocks 320, 330, and 340 are range, Doppler, azimuth, elevation, and amplitude (i.e., reflected energy level) of each object 140. At this stage, the Doppler information represents any motion that is present whether that motion includes motion of the vehicle 100, relative velocity of the detected object 140, or controlled movement of the radar system 110.

While the processes at blocks 320 through 350 are processes for obtaining information about detected objects 140, additional processes are performed at blocks 360 and 370, according to one or more embodiments, to improve separability among detected objects 140 and the estimation of azimuth angle of each detected object 140. Information used to perform these additional processes includes velocity V of the controlled movement. As discussed with reference to FIG. 2, the controlled movement may be performed for the radar system 110, the array of transmit antennas 111, or individual transmit antennas 111. Output 355n-1 obtained based on the detection at block 350 for the previous frame n−1 is also used.

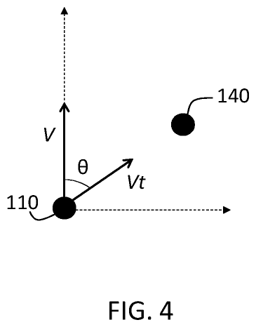

At block 360, isolating antenna movement refers to isolating movement of the transmit antennas 111, individually or collectively. This process uses the known velocity of the vehicle 100 and output 355n for the previous frame to obtain the Doppler component specific to movement of the transmit antennas 111, by removing the Doppler component associated with the object 140. The remaining Doppler is based on the movement of the transmit antennas 111. Specifically, the vector of velocity V of the transmit antennas 111 is obtained at block 360. At block 370, calculating azimuth θ refers to calculating the angle between the vector of velocity V of the transmit antennas 111, obtained at block 360, and the vector of velocity Vt of the object 140, obtained at block 350 as part of the detection. FIG. 4 indicates an azimuth θ according to an exemplary embodiment.

Vₜ=V cos(θ) [EQ. 1]

EQ. 1 may be rewritten as:

$$θ = a cos ( \frac{{V}_{t}}{V} ) \qquad [ EQ . 2 ]$$

The error in the estimate of azimuth θ is based, in part, on the estimation error e_{Vt} in the vector of velocity Vt of the object 140:

$$θ = a cos ( \frac{{V}_{t} + {e}_{Vt}}{V} ) \qquad [ EQ . 3 ]$$

For example, when e_{Vt}=0.009 or 0.1 percent, the error in the estimate of azimuth θ is 0.1 percent. The error in the estimate of azimuth θ is also based, in part, on the estimation error e_{V} in the vector of velocity V of the transmit antennas 111:

$$θ = a cos ( \frac{{V}_{t}}{V + {e}_{V}} ) \qquad [ EQ . 4 ]$$

The source of this error e_{V} is measurement error of the associated one or more accelerometers 215. For example, when e_{V}=0.01 or 0.1 percent, the error in the estimate of azimuth θ is 0.1 percent. As EQS. 3 and 4 indicate, the higher the velocities Vt, V, the higher the accuracy of the estimate of azimuth θ.
The controlled motion amplitude A and frequency f may be used to determine the motion Y of the transmit antennas 111, with t indicating time, as:

Y=A sin(2πft) [EQ. 5]

Then the vector of velocity V of the transmit antennas 111 may be obtained as:

$$V = \frac{dV}{dt} = 2 π fA cos ( 2 π f t ) \qquad [ EQ . 6 ]$$

The frame duration for a desired Doppler accuracy may then be determined. The frame duration TOT is a function of the transmitted wavelength λ and the desired resolution res in meters per second (i.e., Hertz (Hz)). The frame duration TOT may be computed as:

$$TOT = \frac{λ}{10 * 2 res} \qquad [ EQ . 7 ]$$

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A radar system, comprising:
a transmit channel;
a transmit antenna configured to transmit a signal generated by the transmit channel;
a movement device configured to cause controlled movement of the transmit antenna; and
a controller configured to control the movement device, wherein the controlled movement is used to improve an estimate of azimuth angle to an object detected by the radar system.

2. The radar system according to claim 1, wherein the movement device is a Micro-Electro-Mechanical systems (MEMS) or piezoelectric MEMS device.

3. The radar system according to claim 1, further comprising an accelerometer configured to measure the controlled movement.

4. The radar system according to claim 1, further comprising a plurality of the transmit channels.

5. The radar system according to claim 4, further comprising an array of the transmit antennas corresponding to the plurality of the transmit channels.

6. The radar system according to claim 5, wherein the array of the transmit antennas undergoes the controlled movement individually or collectively.

7. The radar system according to claim 6, further comprising a processor configured to process reflections received based on reflection of transmissions of the signal by one or more of the objects, wherein the reflections form a three-dimensional cube of data with a time dimension, a chirp dimension associated with the signal that is transmitted, and a channel dimension.

8. The radar system according to claim 7, wherein the processor is configured to perform a first fast Fourier transform (FFT) to convert the time dimension to a range dimension, perform a second FFT to convert the chirp dimension to a Doppler dimension, and perform a beamforming process to convert the channel dimension to a beam dimension that indicates azimuth angle to the one or more of the objects.

9. The radar system according to claim 8, wherein the processor is further configured to isolate a Doppler component resulting from the controlled movement to obtain a refined azimuth angle to the one or more of the objects.

10. The radar system according to claim 1, wherein the radar system is in or on a vehicle.

11. A method of improving angular localization in a radar system, the method comprising:
coupling a movement device to the radar system to cause controlled movement of a transmit antenna of the radar system that is configured to transmit a signal generated by a transmit channel of the radar system; and
configuring a controller to control the movement device, wherein the controlled movement is used to improve the angular localization including an azimuth angle to an object detected by the radar system.

12. The method according to claim 11, wherein the coupling the movement device includes coupling a Micro-Electro-Mechanical systems (MEMS) or piezoelectric MEMS device to the radar system.

13. The method according to claim 11, further comprising coupling an accelerometer to the radar system to measure the controlled movement.

14. The method according to claim 11, wherein the radar system includes a plurality of the transmit channels and an array of the transmit antennas corresponding to the plurality of the transmit channels, and the coupling the movement device results in individually or collectively moving each of the transmit antennas of the array of the transmit antennas.

15. The method according to claim 14, further comprising processing reflections received based on reflection of transmissions of the signal by one or more of the objects, wherein the reflections form a three-dimensional cube of data with a time dimension, a chirp dimension associated with the signal that is transmitted, and a channel dimension, and the processing also includes performing a first fast Fourier transform (FFT) to convert the time dimension to a range dimension, performing a second FFT to convert the chirp dimension to a Doppler dimension, and performing a beamforming process to convert the channel dimension to a beam dimension that indicates azimuth angle to the one or more of the objects.

16. The method according to claim 15, wherein the processing also includes isolating a Doppler component resulting from the controlled movement to obtain a refined azimuth angle to the one or more of the objects.

17. A vehicle, comprising:
a radar system comprising:
a transmit channel;
a transmit antenna configured to transmit a signal generated by the transmit channel;
a movement device configured to cause controlled movement of the transmit antenna; and
a controller configured to control the movement device, wherein the controlled movement is used to improve an estimate of azimuth angle to an object detected by the radar system; and
a vehicle controller configured to augment or automate operation of the vehicle based on information from the radar system.

18. The vehicle according to claim 17, further comprising a plurality of the transmit channels and an array of the transmit antennas corresponding to the plurality of the transmit channels, wherein the array of the transmit antennas undergoes the controlled movement individually or collectively.

19. The vehicle according to claim 18, further comprising a processor configured to process reflections received based on reflection of transmissions of the signal by one or more of the objects, wherein the reflections form a three-dimensional cube of data with a time dimension, a chirp dimension associated with the signal that is transmitted, and a channel dimension, wherein the processor is configured to perform a first fast Fourier transform (FFT) to convert the time dimension to a range dimension, perform a second FFT to convert the chirp dimension to a Doppler dimension, and perform a beamforming process to convert the channel dimension to a beam dimension that indicates azimuth angle to the one or more of the objects.

20. The vehicle according to claim 19, wherein the processor is further configured to isolate a Doppler component resulting from the controlled movement to obtain a refined azimuth angle to the one or more of the objects.
